(19) United States
(12) Patent Application Publication
(10) Pub. No.: US 2026/0156412 A1
(43) Pub. Date: Jun. 4, 2026

(54) ACOUSTIC SYSTEM, ACOUSTIC SYSTEM CONTROL METHOD, AND ACOUSTIC SYSTEM MANUFACTURING METHOD

(71) Applicants: Panasonic Connect Co., Ltd., Fukuoka (JP); Panasonic Automotive Systems Co., Ltd., Kanagawa (JP)

(72) Inventors: Tatsuya SHIMIZU, Hyogo (JP); Koji SANO, Kanagawa (JP); Yasunori MIYAMOTO, Kanagawa (JP); Keisuke FUJIMOTO, Osaka (JP)

(73) Assignees: Panasonic Connect Co., Ltd., Fukuoka (JP); Panasonic Automotive Systems Co., Ltd., Kanagawa (JP)

(21) Appl. No.: 19/380,525

(22) Filed: Nov. 5, 2025

(30) Foreign Application Priority Data
Nov. 29, 2024 (JP) 2024-208178

(51) Int. Cl. H04R 3/04; H04R 29/00; H04R 31/00

(52) U.S. Cl. CPC H04R 3/04; H04R 29/001; H04R 31/00

(57) ABSTRACT

An acoustic system includes: a vibration component; one or more sound generation devices that generate, based on an acoustic signal, sound directed toward the vibration component; one or more vibrators that are attached to the vibration component and impart vibration to the vibration component; a first signal output device that outputs a first acoustic signal to the one or more sound generation devices; and a second signal output device that outputs, to the one or more vibrators, a second acoustic signal obtained by correcting the first acoustic signal to suppress propagation of sound in a non-propagation area that is outside an area in which propagation of the sound is intended, the sound having been emitted from the one or more sound generation devices based on the first acoustic signal and having passed through the vibration component.

### CROSS REFERENCE TO RELATED APPLICATION

The present application is based on and claims priority of Japanese Patent Application No. 2024-208178 filed on Nov. 29, 2024.

### FIELD

The present disclosure relates to an acoustic system that limits the propagation area of a sound, to an acoustic system control method, and to an acoustic system manufacturing method.

### BACKGROUND ART

Patent Literature (PTL) 1 describes an acoustic system that, in a situation where different sounds are emitted from a plurality of loudspeakers disposed at different locations such as in the cabin of an airplane, prevents sound emitted from a loudspeaker other than a predetermined loudspeaker from reaching a person seated close to the predetermined loudspeaker.

### CITATION LIST

### Patent Literature

PTL 1: Japanese U.S. Pat. No. 6,958,763

### SUMMARY

However, the acoustic system described in aforementioned PTL 1 can be improved upon.

The present disclosure provides an acoustic system, an acoustic system control method, and an acoustic system manufacturing method that are capable of improving upon the related art.

An acoustic system according to an aspect of the present disclosure includes: a vibration component; one or more sound generation devices that generate, based on an acoustic signal, sound directed toward the vibration component; one or more vibrators that are attached to the vibration component and impart vibration to the vibration component; a first signal output device that outputs a first acoustic signal; and a second signal output device that outputs, to the one or more vibrators, a second acoustic signal obtained by correcting the first acoustic signal to suppress propagation of sound in a non-propagation area that is outside an area in which propagation of the sound is intended, the sound having been emitted from the one or more sound generation devices based on the first acoustic signal and having passed through the vibration component.

An acoustic system control method according to an aspect of the present disclosure is an acoustic system control method for setting a filter property of a correction filter included in an acoustic system. The acoustic system includes: a vibration component; one or more sound generation devices that generate, based on an acoustic signal, sound directed toward the vibration component; one or more vibrators that are attached to the vibration component and impart vibration to the vibration component; a first signal output device that outputs a first acoustic signal to the one or more sound generation devices; and a second signal output device that outputs, to the one or more vibrators, a second acoustic signal obtained by correcting the first acoustic signal to suppress propagation of sound in a non-propagation area that is outside an area in which propagation of the sound is intended, the sound having been emitted from the one or more sound generation devices based on the first acoustic signal and having passed through the vibration component. The second signal output device includes a correction filter that corrects the first acoustic signal to output the second acoustic signal to the one or more vibrators; and the correction filter has a filter property that is derived based on a transmission property of sound emitted by the one or more sound generation devices and propagating via the vibration component. The acoustic system control method includes: placing a measurement device in one or more locations inside the non-propagation area; and setting the filter property of the correction filter, based on: a first sound-pressure transfer function between the first acoustic signal and a first measurement signal obtained by way of the measurement device measuring sound emitted from the one or more sound generation devices based on the first acoustic signal and propagating via the vibration component; and a second sound-pressure transfer function between the second acoustic signal and a second measurement signal obtained by way of the measurement device measuring sound emitted from the vibration component according to excitation force generated by the one or more vibrators based on the second acoustic signal.

An acoustic system manufacturing method according to an aspect of the present disclosure is an acoustic system manufacturing method for manufacturing an acoustic system by setting a filter property of a correction filter included in the acoustic system. The acoustic system includes: a vibration component; one or more sound generation devices that generate, based on an acoustic signal, sound directed toward the vibration component; one or more vibrators that are attached to the vibration component and impart vibration to the vibration component; a first signal output device that outputs a first acoustic signal to the one or more sound generation devices; and a second signal output device that outputs, to the one or more vibrators, a second acoustic signal obtained by correcting the first acoustic signal to suppress propagation of sound in a non-propagation area that is outside an area in which propagation of the sound is intended, the sound having been emitted from the one or more sound generation devices based on the first acoustic signal and having passed through the vibration component. The second signal output device includes a correction filter that corrects the first acoustic signal to output the second acoustic signal to the one or more vibrators; and the correction filter has a filter property that is derived based on a transmission property of sound emitted by the one or more sound generation devices and propagating via the vibration component. The acoustic system manufacturing method includes: placing a measurement device in one or more locations inside the non-propagation area; and setting the filter property of the correction filter, based on: a first sound-pressure transfer function between the first acoustic signal and a first measurement signal obtained by way of the measurement device measuring sound emitted from the vibration component according to excitation force generated by the one or more sound generation devices based on the first acoustic signal; and a second sound-pressure transfer function between the second acoustic signal and a second measurement signal obtained by way of the measurement device measuring sound emitted from the vibration component according to excitation force generated by the one or more vibrators based on the second acoustic signal.

An acoustic system, an acoustic system control method, and an acoustic system manufacturing method according to the present disclosure are capable of improving upon the related art.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a perspective view of an acoustic system.

FIG. 2 is a perspective view of the acoustic system with a portion of a casing thereof being omitted.

FIG. 3 is a diagram illustrating the functional configuration of the acoustic system.

FIG. 4 is a diagram illustrating a property generation system in a first measurement mode.

FIG. 5 is a diagram illustrating the property generation system in a second measurement mode.

FIG. 6 is a diagram illustrating the property generation system in a third measurement mode.

FIG. 7 is a perspective view of Other Example 1 of the acoustic system.

FIG. 8 is a perspective view of Other Example 2 of the acoustic system with a portion of a casing thereof being omitted.

### DESCRIPTION OF EMBODIMENTS

Hereinafter, embodiments of an acoustic system, an acoustic system control method, and an acoustic system manufacturing method according to the present disclosure will be described with reference to the Drawings. It should be noted that each of the subsequent embodiments shows an example for describing the present disclosure, and thus is not intended to limit the present disclosure. For example, the shapes, structures, materials, structural components, the relative positional relationships and connections of the structural components, numerical values, formulas, steps, the processing order of the steps, and so on, shown in the following embodiments are mere examples, and details not described below may be included. Furthermore, although there are cases where geometric expressions, such as “parallel” and “orthogonal”, are used, these expressions are not mathematically precise indications and include substantially permissible error, deviation, and the like. Moreover, expressions such as “simultaneous” and “identical (or the same)” are considered to cover a substantially permissible range of meaning.

Additionally, the drawings are schematic illustrations that may include emphasis, omission, or adjustment of proportion as necessary for the purpose of describing the present disclosure, and thus the shapes, positional relationships, and proportions shown may be different from actuality.

Furthermore, hereinafter, multiple inventions may be comprehensively described as a single embodiment. Moreover, part of the contents in the description below is described as an optional element related to the present disclosure.

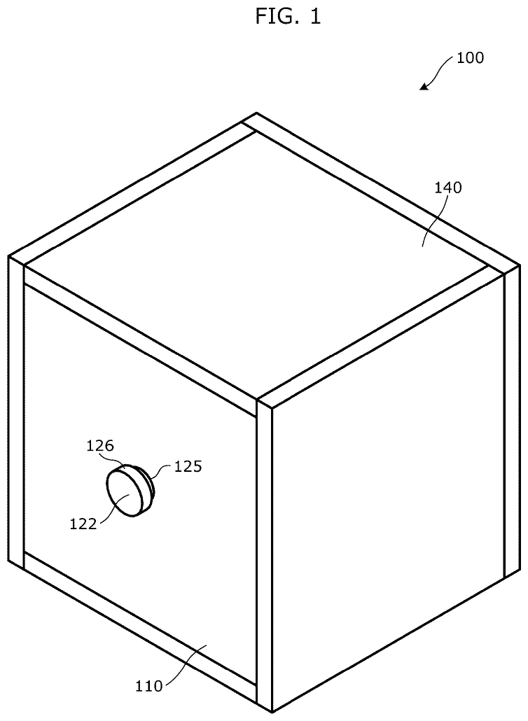

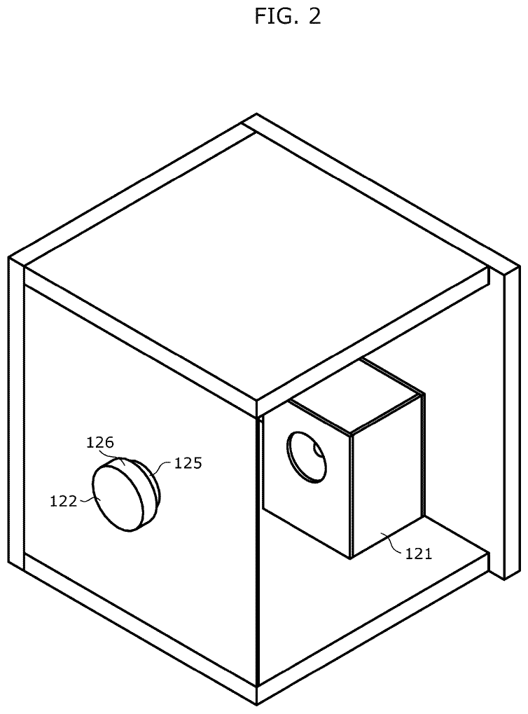

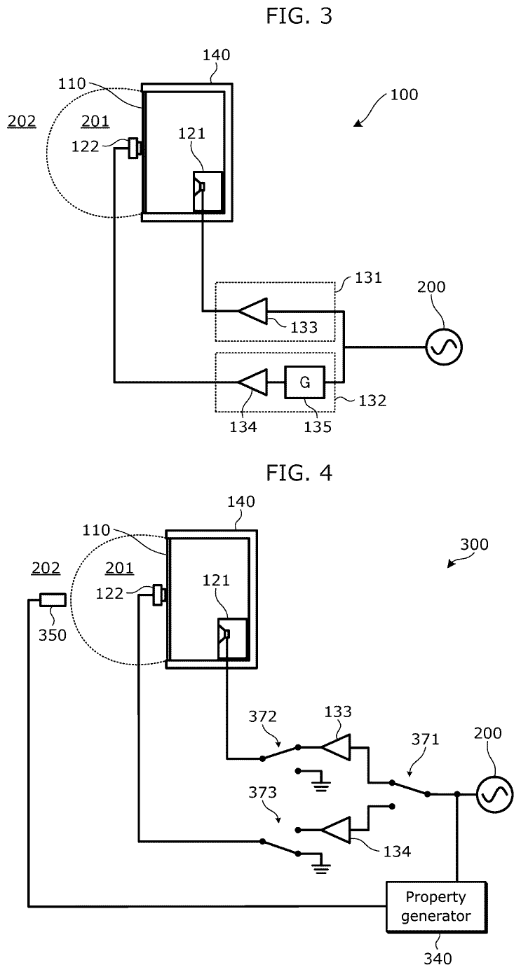

FIG. 1 is a perspective view of acoustic system 100. FIG. 2 is a perspective view of acoustic system 100 with a portion of casing 140 thereof being omitted. FIG. 3 is a diagram illustrating the functional configuration of acoustic system 100. Acoustic system 100 is a system capable of causing propagation of sound in propagation area 201 (see FIG. 3), and suppressing the propagation of sound in non-propagation area 202 which is outside propagation area 201. Acoustic system 100 includes vibration component 110, sound generation device 121, vibrator 122, first signal output device 131, and second signal output device 132. In the present embodiment, acoustic system 100 includes casing 140, and fixing component 150.

Vibration component 110 is a component to which sound generation device 121 imparts vibration. The material and shape of vibration component 110 is not limited. For example, vibration component 110 can be exemplified by a rectangular plate-shaped component made of metal, resin, wood, or other material. In the present embodiment, vibration component 110 is formed using a plate-shaped component whereby, within the frequency range of sound included in a first acoustic signal reproduced by acoustic system 100, the propagation speed of bending waves propagating in vibration component 110 does not exceed the speed of sound in normal temperature air. Specifically, bending rigidity B and distribution mass M of vibration component 110 are adjusted so that, in the vibration frequency range of the vibration imparted by sound generation device 121, propagation speed Cp of the bending wave generated in vibration component 110 becomes slower than speed of sound in air Cair≈340 m/s, air being the medium of propagation area 201. With this, non-progressive waves which do not propagate to non-propagation area 202 can be easily generated in propagation area 201 close to vibration component 110 through the operation of sound generation device 121 and second vibrators 122. Furthermore, for vibration component 110, a plate material for which Young's modulus E, material density ρ, Poisson's ratio ν, and thickness h are uniformly distributed is preferrable. Vibration component 110 blocks the opening of rectangular box-shaped casing 140, and is held by casing 140 in such a way that the inside of casing 140 becomes a sealed space. For thickness h of vibration component 110, for f=20 kHz at which bending wave propagation speed Cp becomes faster within a frequency range of the audible band, bending rigidity B and distributed mass M=ρh are adjusted under a first condition so that, with respect to Young's modulus E, material density ρ, and Poisson's ratio ν of vibration component 110, bending wave propagation speed Cp becomes faster than speed of sound in air Cair≈340 m/s.

It should be noted that bending wave propagation speed Cp is calculated using Expression 1 below.

$$Cp = {( B / M )}^{( 1 / 4 )} \times {2}^{( 1 / 2 )} \times {( π f )}^{( 1 / 2 )} \qquad Expression 1$$

The first condition is a case in which Expression 2 below is satisfied.

$$h < ( {Cair}^{2 / π f} ) \times {( ( 3 \times ρ \times ( 1 - {v}^{2} ) ) / E )}^{( 1 / 2 )} \qquad Expression 2$$

Bending rigidity B is calculated using Expression 3 below.

$$B = {h}^{3} \times E / ( 12 \times ( - {v}^{2 + 1} ) ) \qquad Expression 3$$

Sound generation device 121 is a device that generates sound directed toward vibration component 110, based on the first acoustic signal. Acoustic system 100 may include one sound generation device 121 or a plurality of sound generation devices 121. The type of sound generation device 121 is not limited. For example, sound generation device 121 can be exemplified by a loudspeaker unit, a sound-generation vibrator that causes a target object to vibrate to thereby emit sound, or the like. Furthermore, sound generation device 121 may include a cabinet (enclosure) that houses the loudspeaker unit, a vibration component to which the sound-generation vibrator is attached, or the like. Furthermore, sound generation device 121 may include a plurality of loudspeaker units or a plurality of sound-generation vibrators, or sound generation device 121 may be a multi-way loudspeaker that includes multiple types of loudspeaker units. In the present embodiment, sound generation device 121 is a closed-back loudspeaker that includes a cabinet that houses a loudspeaker unit with the backside of the loudspeaker unit in a sealed state. Sound generation device 121 is disposed in a state in which it is housed in the inside of casing 140.

Vibrator 122 is an actuator (exciter) that is attached to vibration component 110, and imparts vibration to vibration component 110 according to the excitation force generated based on a second acoustic signal. Vibrator 122 may be of the same type or a different type as the vibrator that may be used in sound generation device 121. Vibrator 122 includes: second movable portion 125 that is connected to vibration component 110; second base portion 126; and a vibration unit (not shown in the figures) that generates excitation force between second movable portion 125 and second base portion 126. The type of the vibration unit of vibrator 122 is not limited, and can be exemplified by a type that uses a magnet, a type that uses a piezoelectric element, a type that uses a magnetostrictive element, or the like. Vibrator 122 can be exemplified by a vibrator that uses inertial force generated by the mass effect of second base portion 126, a vibrator that uses structural reaction force generated by coupling one end of second base portion 126 to another structural component, or the like. Furthermore, acoustic system 100 may include one vibrator 122 or a plurality thereof. The attachment position of vibrator 122 is not limited. In the present embodiment, vibrator 122 is attached to a first face located on the reverse side of a second face of vibration component 110 to which sound generation device 121 is attached. Acoustic system 100 includes a single vibrator 122 in a center portion of vibration component 110.

First signal output device 131 is a device that outputs a first acoustic signal to sound generation device 121. First signal output device 131, although not limited to this configuration, includes first driving amplifier 133 in the present embodiment. First driving amplifier 133 is an amplifier that amplifies a first acoustic signal outputted from signal source 200, by driving sound generation device 121 until sound can be emitted from vibration component 110. It should be noted that first signal output device 131 may include any filter such as a delay filter, a correction filter, and so on.

Second signal output device 132 is a device that outputs, to vibrator 122, a second acoustic signal obtained by correcting the first acoustic signal to suppress the propagation of sound, which was emitted from sound generation device 121 based on the first acoustic signal and has passed through vibration component 110, in non-propagation area 202 that is outside propagation area 201 in which propagation of the sound in air is intended. Second signal output device 132, although not limited to this configuration, includes second driving amplifier 134 in the present embodiment. Second driving amplifier 134 amplifies the second acoustic signal that has been corrected to suppress propagation of sound to non-propagation area 202, by driving vibrator 122 to cause vibration component 110 to vibrate. In the present embodiment, second driving amplifier 134 amplifies the second acoustic signal that has been corrected by correction filter 135.

Correction filter 135 is a filter that outputs, to vibrator 122, a second acoustic signal obtained by correcting the first acoustic signal to cause the sound emitted by vibration component 110 that vibrates according to sound generation device 121 to propagate inside propagation area 201 in which propagation of the sound is intended, and to suppress the propagation of sound in non-propagation area 202 to which propagation of the sound is not intended. Propagation area 201 is an area located close to vibration component 110, and non-propagation area 202 is an adjacent area located on a side of propagation area 201 that is farther from vibration component 110 than propagation area 201. Correction filter 135 has an acoustic system 100-specific filter property G. Filter property G of correction filter 135 is derived based on a transmission property of propagating sound emitted as a result of vibrator 122 causing vibration component 110 to vibrate.

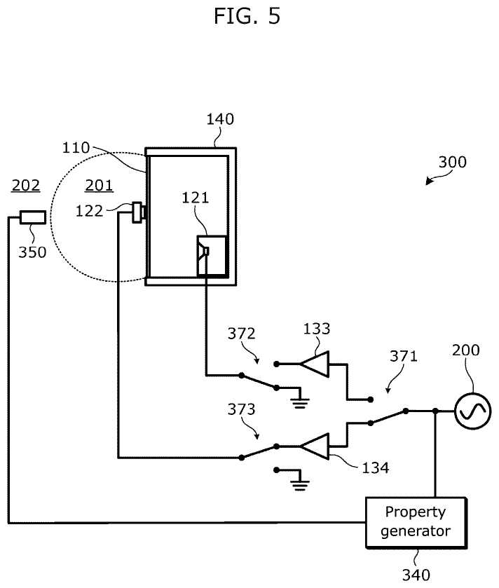

Next, property generation system 300 that is capable of setting filter property G of correction filter 135 included in acoustic system 100 will be described. FIG. 4 is a diagram illustrating property generation system 300 in a first measurement mode. FIG. 5 is a diagram illustrating property generation system 300 in a second measurement mode. Property generation system 300 is a system that generates filter property G of correction filter 135 included in acoustic system 100, and includes: acoustic system 100 whose filter property G is still not set; property generator 340; and measurement device 350. In the present embodiment, acoustic system 100 includes first switch 371, second switch 372, and third switch 373.

The generation of filter property G is executed based on a first acoustic signal used for measuring (hereinafter referred to as a measurement first acoustic signal). For example, as a measurement first acoustic signal, a predetermined acoustic signal, a sine curve signal, a swept sine signal, an impulse signal, a random noise signal, a colored noise signal, an M-sequence signal, a time-stretched pulse (TSP) signal, and so on, can be given as examples.

Measurement device 350 is a device that measures sound generated by acoustic system 100. As measurement device 350 that measures sound, a microphone can be given as an example. It should be noted that, for example, a displacement sensor, a speed sensor, an acceleration sensor, and so on, may be used as measurement device 350.

Measurement device 350 is placed in one or more locations inside non-propagation area 202, and property generator 340 generates filter property G of correction filter 135 based on (i) first sound-pressure transfer function H1 between a first acoustic signal and first measurement signal P1 obtained by measurement device 350 measuring the sound that was emitted from sound generation device 121 based on the first acoustic signal and has passed through vibration component 110 and (ii) second sound-pressure transfer function H2 between a second acoustic signal and second measurement signal P2 obtained by measurement device 350 measuring the sound emitted from vibration component 110 according to the excitation force generated by vibrator 122 based on the first acoustic signal. In the present embodiment, property generator 340 derives filter property G by using Fourier transform. A specific method of deriving will be described later. Property generator 340 is a processing unit implemented by causing a processor included in a dedicated or general-purpose computer to execute a property generation program.

Next, a method of manufacturing acoustic system 100 using property generation system 300 will be described. As illustrated in FIG. 4, acoustic system 100 is disposed at a predetermined location. Furthermore, measurement device 350 is disposed at the boundary between propagation area 201 and non-propagation area 202.

First switch 371 and second switch 372 are switched so that sound is generated by sound generation device 121 according to first acoustic signal S1 (see FIG. 4). At this time, third switch 373 is switched so that vibrator 122 is short-circuited.

First measurement signal P1 is obtained by causing measurement device 350 to measure the sound that was generated from sound generation device 121 and has passed through vibration component 110. Property generator 340 derives first sound-pressure transfer function H1 between first acoustic signal S1 and first measurement signal P1.

Next, first switch 371 and third switch 373 are switched so that sound is generated by vibrator 122 according to second acoustic signal S2 (see FIG. 5). At this time, second switch 372 may be switched so that sound generation device 121 is short-circuited. It should be noted that second acoustic signal S2 is an uncorrected first acoustic signal S1. In other words, second acoustic signal S2 is the same as first acoustic signal S1.

Second measurement signal P2 is obtained by causing measurement device 350 to measure the sound generated by way of vibrator 122 causing vibration component 110 to vibrate based on second acoustic signal S2, without changing the position of measurement device 350 that has measured first measurement signal P1. Property generator 340 derives second sound-pressure transfer function H2 between second acoustic signal S2 and second measurement signal P2, and derives filter property G of correction filter 135 by using second sound-pressure transfer function H2 together with first sound-pressure transfer function H1 derived earlier.

By setting filter property G of correction filter 135 that was generated by property generator 340 to correction filter 135 included in acoustic system 100, acoustic system 100 can be manufactured.

It should be noted that the present invention is not limited to the above-described embodiment. For example, other embodiments that can be realized by arbitrarily combining structural elements described in the present Specification or by removing some of the structural elements may be embodiments of the present disclosure. Furthermore, variations obtainable through various modifications to the above-described embodiment that can be conceived by a person of ordinary skill in the art without departing from the essence of the present disclosure, that is, the meaning of the recitations in the Claims are included in the present disclosure.

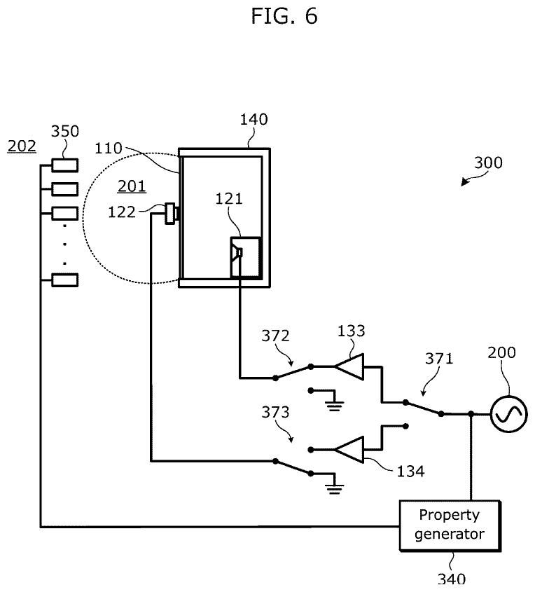

For example, although the case where filter property G for correction filter 135 is derived with first measurement signal P1 and second measurement signal P2 being measured by measurement device 350 disposed in one location, as illustrated in FIG. 6, filter property G may be derived by measuring a plurality of first measurement signals P1 and a plurality of second measurement signals P2 by placing a plurality of measurement devices 350 at multiple positions or by changing the position of measurement device 350. In this case, filter property G of the correction filter may be derived based on (i) first sound-pressure transfer function H1 between first acoustic signal S1 and a first processed signal obtained by performing statistical processing on first measurement signals P1 measured at a number of positions that are different from the number of sound generation devices 121 attached to vibration component 110 and (ii) second sound-pressure transfer function H2 between second acoustic signal S2 and a second processed signal obtained by performing statistical processing on second measurement signals P2 measured at a number of positions different from the number of vibrators 122 attached to vibration component 110.

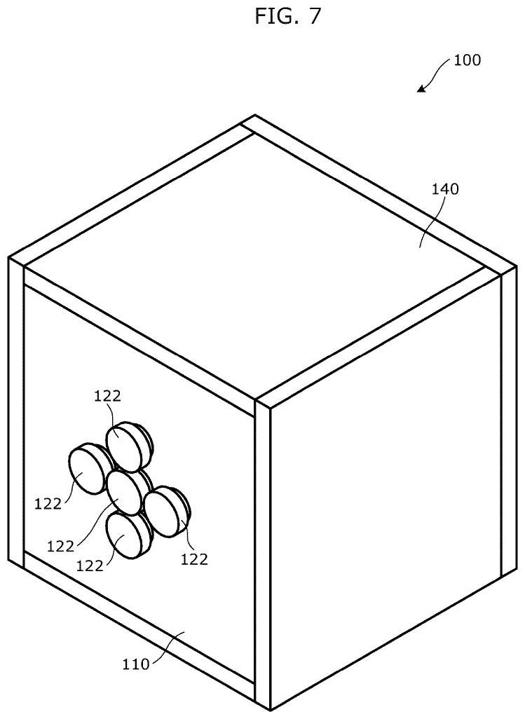

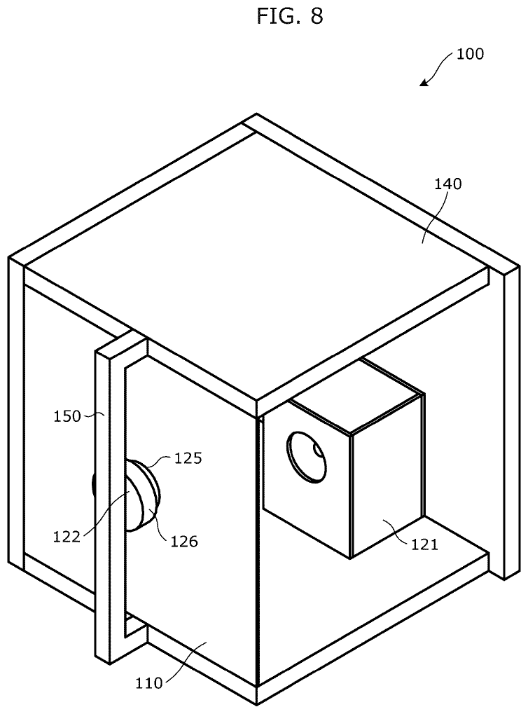

Furthermore, as illustrated in FIG. 7, a plurality of vibrators 122 may be attached to vibration component 110. Furthermore, vibrator 122 may be attached to the second face which is the sound generation device 121-side face of vibration component 110.

Furthermore, although a case is exemplified in which acoustic system 100 is manufactured by setting, to correction filter 135, filter property G derived from measurement results based on property generation system 300, filter property G of correction filter 135 may be derived through numerical analysis simulation such as Finite Element Method (FEM) or Limit Equilibrium Method (LEM: equilibrium circuit analysis method that uses lumped element) and set to correction filter 135 of acoustic system 100.

Furthermore, a case has been described in which, in property generation system 300, second switch 372 and third switch 373 are disposed on the output terminal side of first driving amplifier 133 and second driving amplifier 134, second switch 372 and third switch 373 may be disposed on the input terminal side of first driving amplifier 133 and second driving amplifier 134. In this case, when a voltage-driven amplifier having a sufficiently low output impedance is used as a measurement amplifier, short-circuiting to the ground potential of the measurement amplifier input terminal can achieve the same effect as short-circuiting a switch disposed on the output terminal side.

Furthermore, as illustrated in FIG. 8, second base portion 126 of vibrator 122 may be connected to fixing component 150.

### CONCLUSION

Acoustic system 100 according to a first aspect includes: vibration component 110; one or more sound generation devices 121 that generate, based on an acoustic signal, sound directed toward vibration component 110; one or more vibrators 122 that are attached to vibration component 110 and impart vibration to vibration component 110; first signal output device 131 that outputs a first acoustic signal to one or more sound generation devices 121; and second signal output device 132 that outputs, to one or more vibrators 122, a second acoustic signal obtained by correcting the first acoustic signal to suppress propagation of sound in non-propagation area 202 that is outside an area in which propagation of the sound is intended, the sound having been emitted from one or more sound generation devices 121 based on the first acoustic signal and having passed through vibration component 110.

According to the first aspect, sound can be propagated in propagation area 201 which is an intended area close to vibration component 110, and propagation of sound can be suppressed in non-propagation area 202 which is an area for which the propagation of sound had been difficult to suppress with a conventional device and method. Therefore, it is possible to create an arbitrary space in which the sound reaches only a person inside propagation area 201 close to acoustic system 100, and the sound does not easily reach a person outside propagation area 201. As such a space, it is possible to create, for example, in the cabin of an airplane or the cabin of a car, a space where sound can reach a person sitting in a predetermined seat, and a person sitting in a different seat can listen to a different sound or enjoy a conversation.

Acoustic system 100 according to a second aspect is acoustic system 100 according to the first aspect, in which, vibration component 110 is in a shape of a plate by which, within a frequency range of sound included in first acoustic signal, a propagation speed of bending waves does not exceed a speed of sound in normal temperature air.

Acoustic system 100 according to a third aspect is acoustic system 100 according to the first aspect or the second aspect, that further includes: casing 140 in which vibration component 110 is held, and that, together with vibration component 110, defines a sealed space. Here, one or more sound generation devices 121 are disposed inside casing 140.

According to the third aspect, sound can be strongly propagated in a predetermined direction.

Acoustic system 100 according to a fourth aspect is acoustic system 100 according to any one of the first aspect to the third aspect, that further includes: fixing component 150 that fixes a portion of each of one or more vibrators 122, the portion being on a side of that vibrator 122 that is farther from vibration component 110.

According to the fourth aspect, by coupling second base portion 126 included in one or more vibrators 122 to fixing component 150, it is possible to cause vibration component 110 to vibrate, by using structural reaction force. Therefore, for example, even if one or more vibrators 122 are light, excitation force can be effectively imparted to vibration component 110, and thus propagation of sound in non-propagation area 202 can be effectively suppressed.

Acoustic system 100 according to a fifth aspect is acoustic system 100 according to any one of the first aspect to the fourth aspect, in which: second signal output device 132 includes correction filter 135 that corrects the first acoustic signal to output the second acoustic signal to one or more vibrators 122; and correction filter 135 has filter property G that is derived based on a transmission property of sound emitted by one or more sound generation devices 121 and propagating via vibration component 110.

An acoustic system control method according to a sixth aspect is an acoustic system control method for setting filter property G of correction filter 135 included in acoustic system 100 according to the fifth aspect. The acoustic system control method includes: placing measurement device 350 in one or more locations inside non-propagation area 202; and setting filter property G of correction filter 135, based on: a first sound-pressure transfer function between the first acoustic signal and a first measurement signal obtained by way of measurement device 350 measuring sound emitted from one or more sound generation devices 121 based on the first acoustic signal and propagating via vibration component 110; and a second sound-pressure transfer function between the second acoustic signal and a second measurement signal obtained by way of measurement device 350 measuring sound emitted from vibration component 110 according to excitation force generated by one or more vibrators 122 based on the second acoustic signal.

An acoustic system manufacturing method according to a seventh aspect is an acoustic system manufacturing method for manufacturing acoustic system 100 according to the fifth aspect by setting filter property G of correction filter 135 included in acoustic system 100. The acoustic system manufacturing method includes: placing measurement device 350 in one or more locations inside non-propagation area 202; and setting filter property G of correction filter 135, based on: a first sound-pressure transfer function between the first acoustic signal and a first measurement signal obtained by way of measurement device 350 measuring sound emitted from vibration component 110 according to excitation force generated by one or more sound generation devices 121 based on the first acoustic signal; and a second sound-pressure transfer function between the second acoustic signal and a second measurement signal obtained by way of measurement device 350 measuring sound emitted from vibration component 110 according to excitation force generated by one or more vibrators 122 based on the second acoustic signal.

According to the sixth aspect and the seventh aspect, it is possible to appropriately set filter property G of correction filter 135 that corresponds to acoustic system 100. Accordingly, sound emitted from one or more sound generation devices 121 can be propagated in propagation area 201 which is an intended area, and propagation of the sound to non-propagation area 202 can be suppressed.

An acoustic system manufacturing method according to an eighth aspect is the acoustic system manufacturing method according to the seventh aspect, that further includes: obtaining the first measurement signal in a state in which one or more vibrators 122 are short-circuited.

An acoustic system manufacturing method according to a ninth aspect is the acoustic system manufacturing method according to the seventh aspect, that further includes: obtaining the second measurement signal in a state in which one or more sound generation devices 121 are short-circuited.

According to the eighth and the ninth aspects, the effect on the measurement that is imparted by one or more vibrators 122 that are not running or one or more sound generation devices 121 that are not running can be reduced.

An acoustic system manufacturing method according to a tenth aspect is the acoustic system manufacturing method according to any one of the seventh aspect to the ninth aspect, in which, in the setting of filter property G of correction filter 135, filter property G is set based on: a first sound-pressure transfer function between the first acoustic signal and a first processed signal obtained by performing statistical processing on first measurement signals measured at a total number of positions different from a total number of one or more sound generation devices 121; and a second sound-pressure transfer function between the second acoustic signal and a second processed signal obtained by performing statistical processing on second measurement signals measured at a total number of positions different from a total number of one or more vibrators 122 attached to vibration component 110.

When the number of measurement signals (i.e., the number of measurement positions) and the number of one of one or more sound generation devices 121 or one or more vibrators 122 that are running during measurement match, there is a possibility that an unintended processed signal is created because the derived filter property G is uniquely determined. In contrast, according to the tenth aspect, by adopting a configuration in which the number of measurement signals (the number of measurement positions) and the number of vibrators do not match, an unintended processed signal is not created, and a robust correction filter can be calculated.

### FURTHER INFORMATION ABOUT TECHNICAL BACKGROUND TO THIS APPLICATION

The disclosure of the following patent application including specification, drawings, and claims is incorporated herein by reference in its entirety: Japanese Patent Application No. 2024-208178 filed on Nov. 29, 2024.

### INDUSTRIAL APPLICABILITY

The present disclosure is usable in an acoustic system, or the like, that is disposed in a space where people are densely gathered such as in the cabin of an airplane, the cabin of an automobile, an office, a restaurant, and so on.

1. An acoustic system comprising:
a vibration component;
one or more sound generation devices that generate, based on an acoustic signal, sound directed toward the vibration component;
one or more vibrators that are attached to the vibration component and impart vibration to the vibration component;
a first signal output device that outputs a first acoustic signal to the one or more sound generation devices; and
a second signal output device that outputs, to the one or more vibrators, a second acoustic signal obtained by correcting the first acoustic signal to suppress propagation of sound in a non-propagation area that is outside an area in which propagation of the sound is intended, the sound having been emitted from the one or more sound generation devices based on the first acoustic signal and having passed through the vibration component.

2. The acoustic system according to claim 1, wherein
the vibration component is in a shape of a plate by which, within a frequency range of sound included in the first acoustic signal, a propagation speed of bending waves does not exceed a speed of sound in normal temperature air.

3. The acoustic system according to claim 1, further comprising:
a casing in which the vibration component is held, and that, together with the vibration component, defines a sealed space, wherein
the one or more sound generation devices are disposed inside the casing.

4. The acoustic system according to claim 1, further comprising:
a fixing component that fixes a portion of each of the one or more vibrators, the portion being on a side of the vibrator that is farther from the vibration component.

5. The acoustic system according to claim 1, wherein
the second signal output device includes:
a correction filter that corrects the first acoustic signal to output the second acoustic signal to the one or more vibrators, and
the correction filter has a filter property that is derived based on a transmission property of sound emitted by the one or more sound generation devices and propagating via the vibration component.

6. An acoustic system control method for setting the filter property of the correction filter included in the acoustic system according to claim 5, the acoustic system control method comprising:
placing a measurement device in one or more locations inside the non-propagation area; and
setting the filter property of the correction filter, based on:
a first sound-pressure transfer function between the first acoustic signal and a first measurement signal obtained by way of the measurement device measuring sound emitted from the one or more sound generation devices based on the first acoustic signal and propagating via the vibration component; and
a second sound-pressure transfer function between the second acoustic signal and a second measurement signal obtained by way of the measurement device measuring sound emitted from the vibration component according to excitation force generated by the one or more vibrators based on the second acoustic signal.

7. An acoustic system manufacturing method for manufacturing the acoustic system according to claim 5 by setting the filter property of the correction filter included in the acoustic system, the acoustic system manufacturing method comprising:
placing a measurement device in one or more locations inside the non-propagation area; and
setting the filter property of the correction filter, based on:
a first sound-pressure transfer function between the first acoustic signal and a first measurement signal obtained by way of the measurement device measuring sound emitted from the vibration component according to excitation force generated by the one or more sound generation devices based on the first acoustic signal; and
a second sound-pressure transfer function between the second acoustic signal and a second measurement signal obtained by way of the measurement device measuring sound emitted from the vibration component according to excitation force generated by the one or more vibrators based on the second acoustic signal.

8. The acoustic system manufacturing method according to claim 7, further comprising:
obtaining the first measurement signal in a state in which the one or more vibrators are short-circuited.

9. The acoustic system manufacturing method according to claim 7, further comprising:
obtaining the second measurement signal in a state in which the one or more sound generation devices are short-circuited.

10. The acoustic system manufacturing method according to claim 7, wherein
in the setting of the filter property of the correction filter, the filter property is set based on:
a first sound-pressure transfer function between the first acoustic signal and a first processed signal obtained by performing statistical processing on first measurement signals measured at a total number of positions different from a total number of the one or more sound generation devices; and
a second sound-pressure transfer function between the second acoustic signal and a second processed signal obtained by performing statistical processing on second measurement signals measured at a total number of positions different from a total number of the one or more vibrators attached to the vibration component.
